(19) United States
(12) Patent Application Publication
(10) Pub. No.: US 2025/0188979 A1
(43) Pub. Date: Jun. 12, 2025

(54) FASTENING MEMBER

(71) Applicant: AOYAMA SEISAKUSHO CO., LTD., Niwa-gun (JP)

(72) Inventors: Tomohiro Ogura, Aichi (JP); Hideharu Koketsu, Aichi (JP)

(73) Assignee: AOYAMA SEISAKUSHO CO., LTD., Niwa-gun (JP)

(21) Appl. No.: 18/934,610

(22) Filed: Nov. 1, 2024

(30) Foreign Application Priority Data
Dec. 11, 2023 (JP) 2023-208768

(51) Int. Cl. F16B 35/06

(52) U.S. Cl. CPC F16B 35/06

(57) ABSTRACT

A fastening member includes a thread forming portion and a bearing surface forming portion. The bearing surface forming portion includes a flange at a position closer to the bearing surface, the flange being formed in a shape expanding outward in a radial direction and configured to apply a compressive force to the target fastening member. The flange includes an inclined surface on a surface opposite to the bearing surface, the inclined surface being inclined so as to come closer to the bearing surface as going toward an outside in the radial direction. The inclined surface includes an inner inclined surface and an outer inclined surface located outside the inner inclined surface in the radial direction and having a larger inclination angle with respect to the bearing surface than the inner inclined surface.

### BACKGROUND OF THE INVENTION

### Cross-Reference

This application claims priority to Japanese patent application No. 2023-208768 filed on Dec. 11, 2023, the contents of which are fully incorporated herein by reference.

### Technical Field

This disclosure relates to a fastening member.

### Background Art

Japanese Patent No. 6400647 discloses that an annular groove is provided to a washer for use in a fastening part provided between a vehicle component and a vehicle structure body. It is disclosed that this configuration makes it possible to strengthen the fastening, thereby improving vehicle handling stability.

### SUMMARY OF THE INVENTION

According to the above technique, the vehicle weight increases because a washer is added to the fastening part. As a means of strengthening the fastening without using any washers, a fastening member with a flange (e.g., flanged bolt and flanged nut) can be used. However, in order to increase the rigidity of the flanged bolt to strengthen the fastening, the thickness of the flange needs to be increased. As a result, the weight of the flanged bolt increases accordingly.

The present disclosure has been made in view of such background, and intends to provide a fastening member capable of strengthening fastening while curtailing an increase in weight.

One aspect of the present disclosure is a fastening member including:

a thread forming portion having an external thread or an internal thread formed thereon; and

a bearing surface forming portion including a bearing surface abutting on a target fastening member, wherein

the bearing surface forming portion includes a flange at a position closer to the bearing surface, the flange being formed in a shape expanding outward in a radial direction and configured to apply a compressive force to the target fastening member,

the flange includes an inclined surface on a surface opposite to the bearing surface, the inclined surface being inclined so as to come closer to the bearing surface as going toward an outside in the radial direction, and

the inclined surface includes
an inner inclined surface, and
an outer inclined surface located outside the inner inclined surface in the radial direction and having a larger inclination angle with respect to the bearing surface than the inner inclined surface.

Another aspect of the present disclosure is a fastening member including:

a thread forming portion having an external thread or an internal thread formed thereon, and

a bearing surface forming portion including a bearing surface abutting on a target fastening member, wherein

the bearing surface forming portion includes a flange at a position closer to the bearing surface, the flange being formed in a shape expanding outward in a radial direction and configured to apply a compressive force to the target fastening member,

the flange includes a recess formed on a surface opposite to the bearing surface, and

the recess has a shape with an outermost edge of the recess in the radial direction is located closest to the bearing surface.

According to one aspect of the present disclosure, the outer inclined surface has an inclination angle larger than the inner inclined surface. The outer inclined surface is located outside the inner inclined surface in the radial direction. Thus, in the flange, the thickness of the radially inner portion, which significantly contributes to rigidity, can be effectively increased. As a result, the rigidity of the flange can be increased. In addition, in the flange, an increase in thickness of the radially outer portion, where the axial direction stress is low, can be curtailed. As a result, an increase in weight of the fastening member can be curtailed.

According to another aspect of the present disclosure, a recess is formed in the flange on the surface opposite to the bearing surface. Thus, a concentration point of internal stress in the flange at fastening can be created at the recess. Therefore, fastening can be made stronger than when the concentration point of internal stress in the flange exists only in the innermost radial portion of the flange. Moreover, the recess is formed in such a way that the outermost edge of the recess is located closest to the bearing surface in the radial direction. Therefore, the reduction in rigidity of the flange due to the formation of the recess can be minimized.

As described above, according to the above aspects, it is possible to provide a fastening member that can make the fastening stronger while curtailing increase in weight.

### BRIEF DESCRIPTION OF THE DRAWINGS

FIG. 1 is a cross-sectional view in an axial direction, showing a fastening structure in the first embodiment.

FIG. 2 is a cross-sectional view in the axial direction, of an enlarged flange in FIG. 1.

FIGS. 3(a)-3(c) is a view showing the results of stress analysis on the first embodiment.

FIG. 4 is a cross-sectional view in the axial direction, showing the flange of the fastening structure in the second embodiment.

FIG. 5 is a cross-sectional view in the axial direction, showing the flange of the fastening structure in the third embodiment.

FIG. 6 is a cross-sectional view in the axial direction, showing the fastening structure in the fourth embodiment.

### DETAILED DESCRIPTION OF PREFERRED EMBODIMENTS

A fastening member has a thread forming portion and a bearing surface forming portion. The bearing surface forming portion includes a flange that is formed at a position closer to the bearing surface in a shape expanding outward in a radial direction and is configured to apply a compressive force to a target fastening member. The flange includes an inclined surface on the surface opposite to the bearing surface. The inclined surface is inclined so as to come closer to the bearing surface from the inside to the outside in the radial direction. The inclined surface includes an inner inclined surface and an outer inclined surface. The outer inclined surface is located outside the inner inclined surface in the radial direction and has an larger inclination angle with respect to the bearing surface than the inner inclined surface.

In the fastening member, a boundary between the inner inclined surface and the outer inclined surface may be located inside an outermost abutting portion abutting on the target fastening member at an outermost position in the radial direction of the bearing surface. The inclination angle changes at the boundary. Thus, in the flange, an increase in thickness of a radial direction outer side portion, where the axial direction stress is low, can be effectively curtailed.

In the fastening member, the inner inclined surface may have the inclination angle of 20° to 30° and the outer inclined surface may have the inclination angle of 35° to 50°. Thus, in the flange, the thickness of the radially inner portion, which significantly contributes to rigidity, can be effectively increased. In addition, in the flange, an increase in thickness of the radially outer portion, where the axial direction stress is low, can be effectively curtailed.

In the fastening member, the flange may include a recess formed between the inner inclined surface and the outer inclined surface on the surface opposite to the bearing surface. Thus, a concentration point of internal stress in the flange at the time of fastening can be created at the recess. As a result, the fastening can be made stronger than when the concentration point of internal stress in the flange exists only at the innermost radial portion of the flange.

In the fastening member, the recess may be formed inside the outermost abutting portion abutting on the target fastening member at an outermost position in the radial direction. Thus, the concentration point of internal stress created by the recess can effectively exert axial direction stress on the target fastening member. As a result, the fastening can be made stronger.

In the fastening member, the recess has a shape obtained by notching the surface of the flange opposite to the bearing surface so as to have an L-shape in an axial cross-section. Thus, the reduction in rigidity of the flange due to the recess can be curtailed.

Furthermore, the concentration point of internal stress in the flange at the time of fastening can be effectively created at the recess.

In the fastening member, the recess may be formed in a shape with an outermost edge of the recess in the radial direction located closest to the bearing surface. Thus, the reduction in rigidity of the flange due to the recess can be curtailed.

In the fastening member, the recess may be formed in the flange between the innermost portion and the outermost abutting portion in the radial direction. The innermost portion of the flange is located innermost in the radial direction of the flange.

The outermost abutting portion of the flange is abutting on the target fastening member at the outermost position in the radial direction. Furthermore, the recess may be formed in the flange between the outermost radial portion and the innermost radial portion in an axial direction. The outermost radial portion of the flange is located outermost in the radial direction. Thus, the reduction in rigidity of the flange due to the recess can be curtailed. Furthermore, a concentration point of internal stress in the flange at the time of fastening can be effectively created at the recess.

In the fastening member, the recess may be configured to intersect with a virtual line. The virtual line bisects a radial distance between the innermost radial portion and the outermost abutting portion and is parallel to the axial direction. Thus, the reduction in rigidity of the flange due to the recess can be curtailed. Furthermore, the concentration point of internal stress in the flange at the time of fastening can be effectively created at the recess.

In the fastening member, the inner inclined surface and the outer inclined surface may be formed in a linearly tapered shape in a cross section in the axial direction. Thus, in the flange, the thickness of the radially inner portion, which significantly contributes to rigidity, can be effectively increased. Furthermore, in the flange, the increase in thickness of the radially outer portion, where the axial direction stress is low, can be effectively increased.

### First Embodiment

### 1. Configuration of Fastening Structure 1

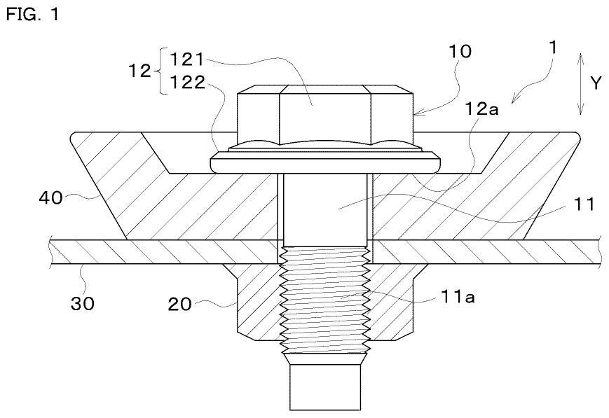

Fastening structure 1 in the first embodiment will be described with reference to FIGS. 1 to 3. In the fastening structure 1, a rear absorber, which constitutes an undercarriage component of an automobile, is fastened to the body of the automobile using a first fastening member 10.

The fastening structure 1 in the first embodiment includes the first fastening member 10, a second fastening member 20, a first target fastening member 30, and a second target fastening member 40, as shown in FIG. 1. In the fastening structure 1, the first fastening member 10 and the second fastening member 20 are used to fasten the first target fastening member 30 and the second target fastening member 40. In the first embodiment, the first target fastening member 30 is, for example, a steel plate constituting a body of an automobile, and the second target fastening member 40 is, for example, a bracket for fixing a rear absorber of an automobile to the body of the automobile.

As shown in FIG. 1, the first fastening member 10 is a bolt including a thread forming portion 11 and a bearing surface forming portion 12. In the first embodiment, the first fastening member 10 is, for example, a bolt with a thread diameter (nominal diameter) of 10 mm. The thread forming portion 11 is a bolt shaft with an external thread 11a. The bearing surface forming portion 12 is a bolt head and includes a bearing surface 12a that abuts on the second target fastening member 40. The bearing surface forming portion 12 is disposed in a coaxial manner with the thread forming portion 11 and has a larger radial direction dimension than the thread forming portion 11. The external thread 11a of the thread forming portion 11 may be formed only in the middle portion of the thread forming portion 11, as shown in FIG. 1, or may be formed over the entire length of the thread forming portion 11, although not shown.

The first fastening member 10 is a flanged bolt. That is, the bearing surface forming portion 12 of the first fastening member 10 is a flanged bolt head. Specifically, the bearing surface forming portion 12 includes a head main body 121 and a flange 122. In the first embodiment, the head main body 121 is formed in the shape of a hexagonal head, however, the head main body 121 may be formed in a shape other than hexagonal and may be formed in the shape of a socket head or a recessed head. The flange 122 is formed in a shape expanding outward in a radial direction over the entire circumference of the bearing surface forming portion 12 at a position closer to the bearing surface 12a and is configured to apply a compressive force to the second target fastening member 40. The bearing surface 12a of the bearing surface forming portion 12 is formed in a continuous manner by the bottom surface of the head main body 121 and the bottom surface of the flange 122.

In the first embodiment, the width across flats of the head main body 121 of the bearing surface forming portion 12 (diameter of the inscribed circle of the head main body 121) is larger than the diameter of the thread forming portion 11. The diameter of the flange 122 of the bearing surface forming portion 12 is larger than the diameter of the thread forming portion 11 and the width across flats of the head main body 121.

The second fastening member 20 is, for example, a nut provided with an internal thread configured to screw into the external thread 11a of the first fastening member 10. In the first embodiment, the second fastening member 20 is a weld nut that is pre-welded to the first target fastening member 30. A flanged nut that is separate from the first target fastening member 30 or a nut without a flange that is separate from the first target fastening member 30 may be used as the second fastening member 20.

### 2. Detailed Configuration of the Bearing Surface Forming Portion 12 of the First Fastening Member 10

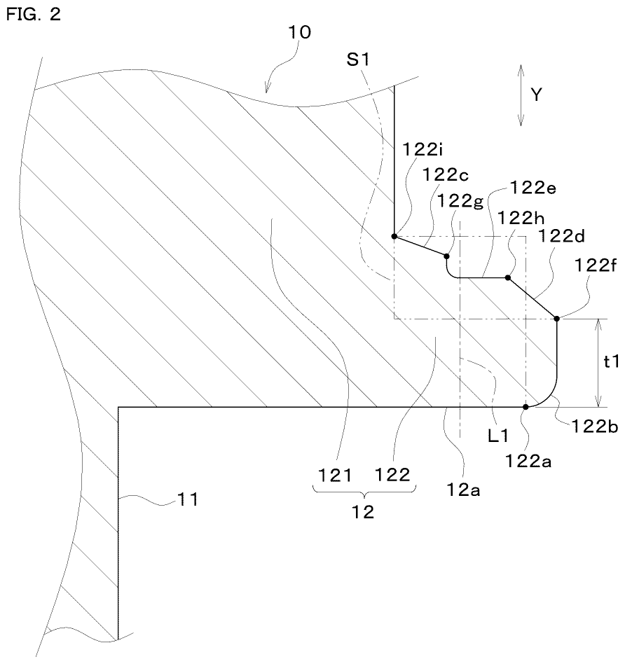

Hereinafter, the portion on the bearing surface 12a of the bearing surface forming portion 12, that abuts on the second target fastening member 40 at the outermost position in the radial direction, is defined as an outermost abutting portion 122a. As shown in FIG. 2, the flange 122 has a chamfer 122b formed near the bearing surface 12a and outside the outermost abutting portion 122a in the radial direction when casting the first fastening member 10.

In the flange 122, the surface opposite to the bearing surface 12a is, as a whole, inclined so as to come closer to the bearing surface 12a as going toward the outside in the radial direction. In the following, the surface opposite to the bearing surface 12a is defined as an inclined surface.

The inclined surface of the flange 122 includes an inner inclined surface 122c, an outer inclined surface 122d, and a recess 122e. The inner inclined surface 122c is connected to the head main body 121. The outer inclined surface 122d is located outside the inner inclined surface 122c in a radial direction. In other words, the inner inclined surface 122c is located radially inner on the inclined surface of the flange 122 and the outer inclined surface 122d is located radially outer on the inclined surface of the flange 122.

In the following, an inclination angle with respect to the bearing surface 12a, which is an acute angle, is defined simply as the inclination angle. The inclination angle of the outer inclined surface 122d is larger than that of the inner inclined surface 122c. The inclination angle of the inner inclined surface 122c is preferably 20° to 30°, and the inclination angle of the outer inclined surface 122d is preferably 35° to 50°. In the first embodiment, the inclination angle of the inner inclined surface 122c is 25° and the inclination angle of the outer inclined surface 122d is 40°.

In the first embodiment, the outer inclined surface 122d is formed up to the outermost radial portion 122f of the flange 122. The flange 122 has a predetermined thickness t1 between the outermost radial portion 122f and the bearing surface 12a.

By setting the inclination angle of the outer inclined surface 122d larger than that of the inner inclined surface 122c, the following effects can be achieved. In the flange 122, the thickness at the position closer to the head main body 121, which significantly contributes to rigidity, can be increased. As a result, the rigidity of the flange 122 can be increased. Furthermore, the increase in thickness of the radial direction outer side portion of the flange 122, where the axial direction stress is low, can be curtailed. As a result, the increase in weight of the first fastening member 10 can be curtailed.

The recess 122e is formed in the inclined surface of the flange 122. The recess 122e is formed in an annular shape over the entire circumference of the flange 122. In the first embodiment, the recess 122e is formed in the boundary between the inner inclined surface 122c and the outer inclined surface 122d. In other words, the recess 122e is connected to the inner inclined surface 122c at an inner position in the radial direction and is connected to the outer inclined surface 122d at an outer position in the radial direction.

In the first embodiment, the inclined surface of the flange 122 has a step shape formed by the recess 122e. The recess 122e has a shape obtained by notching the inclined surface of the flange 122 in an L-shape in an axial cross-section. Specifically, the recess 122e includes a wall surface extending from a connection portion 122g, which connects to the inner inclined surface 122c, in a direction nearly parallel to the axial direction Y of the first fastening member 10 and a bottom surface extending from a connection portion 122h, which connects to the outer inclined surface 122d in a direction nearly orthogonal to the axial direction Y of the first fastening member 10. Thus, the recess 122e comes closer to the bearing surface 12a as going towards the outside in the radial direction, and an outermost edge of the recess 122e comes closest to the bearing surface 12a.

The recess 122e is formed inside the virtual rectangle S1 shown by a two-dotted line in FIG. 2. Specifically, the recess 122e is formed between the innermost radial portion 122i and the outermost abutting portion 122a of the flange 122 in the radial direction of the first fastening member 10. The recess 122e is formed between the innermost radial portion 122i and the outermost radial portion 122f of the flange 122 in the axial direction Y of the first fastening member 10.

In the first embodiment, the recess 122e is configured to intersect with a virtual line L1. The virtual line L1 bisects a radial distance between the innermost radial portion 122i and the outermost abutting portion 122a and is parallel to the axial direction Y.

By forming the recess 122e in the flange 122, a concentration point of internal stress in the flange 122 can be created at the recess 122e when the first fastening member 10 and the second fastening member 20 fasten the first fastening member 30 and the second target fastening member 40. Thus, moment when an external force to pull off the second fastening member 40 from the first fastening member 30 acts on the outermost radial portion of the second fastening member 40 can be made smaller in comparison with the case where the concentration point of the internal stress in the flange 122 exists only at the innermost radial portion 122i of the flange 122. Therefore, the fastening between the first target fastening member 30 and the second target fastening member 40 by the first fastening member 10 and the second fastening member 20 can be made stronger.

### 3. Analysis of Fastening Structure 1

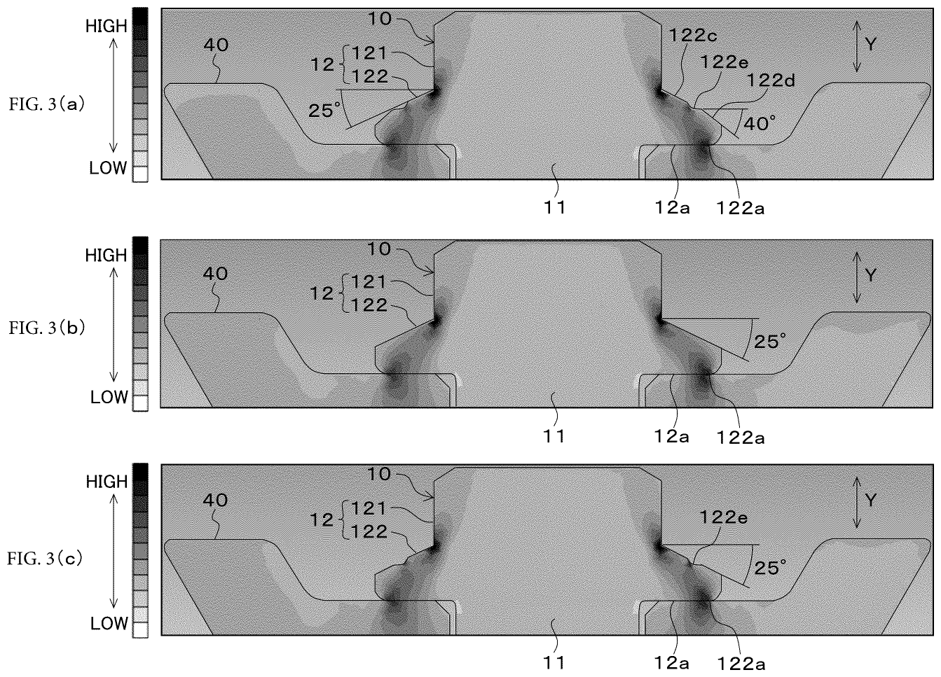

The analysis of the fastening structure 1 is described with reference to FIGS. 3(a)-3(c). The analysis results of Analysis Example 1 corresponding to the first embodiment, Analysis Example 2, and Analysis Example 3 are shown respectively in FIG. 3(a), FIG. 3(b), and FIG. 3(c).

The analytical models used in Analysis Examples 1-3 are each a three-dimensional model that includes the first fastening member 10, the first target fastening member 30, and the second target fastening member 40.

In Analysis Example 1 shown in FIG. 3(a), an analytical model is used in which the inclination angle of the inner inclined surface 122c is 25°, the inclination angle of the outer inclined surface 122d is 40°, and the recess 122e is formed.

In Analysis Example 2 shown in FIG. 3(b), an analytical model is used in which the inclined angle of the inclined surface of the flange 122 is constantly 25° with no variation, and the recess 122e of the first embodiment is not formed in the flange 122.

In Analysis Example 3 shown in FIG. 3(c), an analytical model is used in which the inclined angle of the inclined surface of the flange 122 is constantly 25° with no variation, and the recess 122e similar to the first embodiment is formed in the flange 122.

In the analytical models used in Analysis Examples 1-3, the first target fastening member 30 is made of structural steel, the second target fastening member 40 is made of aluminum alloy. The first fastening member 10 has a Young's modulus of 206 GPa, a Poisson's ratio of 0.3, and a yield stress of 1017 MPa.

In these analytical models, an axial force generated in the first fastening member 10 is 38.6 kN, and a load of 8.4 kN is applied to the outermost radial portion of the second target fastening member 40 in a direction to pull off the second target fastening member 40 from the first target fastening member 30. The analysis results of Analysis Examples 1-3 in FIGS. 3(a) to 3(c) are shown in a contour diagram of an axial direction stress, showing the higher stress with the darker color.

In comparison between Analysis Example 2 shown in FIG. 3(b) and Analysis Example 3 shown in FIG. 3(c), an effect of the recess 122e on the axial direction stresses can be seen. In comparison between Analysis Example 3 shown in FIG. 3(c) and Analysis Example 1 shown in FIG. 3(a), an effect of making the inclination angle of the outer inclined surface 122d larger than that of the inner inclined surface 122c can be seen.

In Analysis Example 2 shown in FIG. 3(b), a concentration point of an axial direction stress is created at the innermost radial portion 122i of the flange 122. However, the axial direction stress transmitted to the radial direction outer side portion of the flange 122 is low.

In contrast, in Analysis Example 3 shown in FIG. 3(c), because the recess 122e is formed in the flange 122, the concentration point of the axial direction stress in the flange 122 is created not only at the innermost radial portion 122i of the flange 122 but also at the recess 122e. Therefore, the axial direction stress transmitted to the radial direction outer side portion of the flange 122 is larger in comparison with Analysis Example 2. However, in Analytical Example 3 shown in FIG. 3(c), the axial direction stress transmitted to the vicinity of the inclined surface of the flange 122 outside the recess 122e in the radial direction is kept low with almost no variation in comparison with Analytical Example 2.

In Analysis Example 1 shown in FIG. 3(a), the inclination angle of the outer inclined surface 122d is set larger than that of the inner inclined surface 122c. Due to such a configuration, the part where the axial direction stress is lower outside the recess 122e in the radial direction can be eliminated, to thereby achieve weight reduction. From the above, it can be seen that Analysis Example 1 corresponding to the first embodiment makes it possible to strengthen the fastening between the first fastening member 30 and the second target fastening member 40 without increasing the weight as much as possible.

### 4. Operational Advantage

In the first fastening member 10 according to the first embodiment, the outer inclined surface 122d of the flange 122 of the first fastening member 10 has the inclination angle larger than that of the inner inclined surface 122c. Thus, in the flange 122, a thickness at a part closer to the head main body 121, which significantly contributes to rigidity. As a result, the rigidity of the flange 122 can be increased. In addition, an increase in thickness of the flange 122 at the radially outer portion, where the axial direction stress is low, can be curtailed. As a result, the increase in weight of the first fastening member 10 can be curtailed. Therefore, the fastening by the first fastening member 10 can be made stronger while the increase in weight of the first fastening member 10 is curtailed.

In the first fastening member 10 according to the first embodiment, the boundary between the inner inclined surface 122c and the outer inclined surface 122d is located inside the outermost abutting portion 122a in the radial direction. The inclination angle changes at the boundary. Thus, in the flange 122, the increase in thickness of the radial direction outer side portion, where the axial direction stress is low, can be effectively curtailed.

In the first fastening member 10 according to the first embodiment, the inner inclined surface 122c has the inclination angle of 20° to 30° and the outer inclined surface 122d has the inclination angle of 35° to 50°. Thus, in the flange 122, the thickness at a part closer to the head main body 121, where significantly contributes to rigidity, can be effectively increased. In addition, in the flange 122, the increase in thickness of the radially outer portion, where the axial direction stress is low, can be effectively curtailed.

In the first fastening member 10 according to this embodiment the recess 122e is formed in the inclined surface of the flange 122. Therefore, the concentration point of internal stress in the flange 122 at the time of fastening can be created at the recess 122e. Therefore, the fastening can be made stronger than when the concentration point of the internal stress in the flange 122 exists only at the innermost radial portion 122i of the flange 122.

In the first fastening member 10 according to the first embodiment, the recess 122e is formed inside the outermost abutting portion 122a of the flange 122 in the radial direction. Thus, the concentration point of internal stress created by the recess 122e can effectively exert axial direction stress on the second target fastening member 40. As a result, the fastening can be made stronger.

In the first fastening member 10 according to the first embodiment, the recess 122e has a shape obtained by notching the inclined surface so as to have an L-shape in an axial cross-sectional. Thus, the reduction in rigidity of the flange 122 due to the recess 122e can be curtailed. Furthermore, the concentration point of internal stress in the flange 122 at the time of fastening can be effectively created at the recess 122e.

In the first fastening member 10 according to the first embodiment, the recess 122e is formed in a shape with the outermost edge of the recess 122e in the radial direction is located closest to the bearing surface 12a. Thus, the reduction in rigidity of the flange 122 due to the recess 122e can be curtailed.

In the first fastening member 10 according to the first embodiment, the recess 122e is formed in the flange 122 between the innermost radial portion 122i and the outermost abutting portion 122a in the radial direction. Furthermore, the recess 122e is formed in the flange 122 between the outermost radial portion 122f and the innermost radial portion 122i in the axial direction. Thus, the reduction in rigidity of the flange 122 due to the recess 122e can be curtailed. Furthermore, the concentration point of internal stress of the flange 122 at the time of fastening the flange can be effectively created at the recess 122e.

In the first fastening member 10 according to the first embodiment, the recess 122e configured to intersect with the virtual line L1. The virtual line L1 bisects the radial distance between the innermost radial portion 122i and the outermost abutting portion 122a of the flange 122 and is parallel to the axial direction Y. Thus, the reduction in rigidity of the flange 122 due to the recess 122e can be curtailed. Furthermore, the concentration point of internal stress of the flange 122 at the time of fastening can be effectively created at the recess 122e.

In the first fastening member 10 according to the first embodiment, the inner inclined surface 122c and the outer inclined surface 122d are formed in a linearly tapered shape in a cross section in the axial direction. Thus, in the flange 122, the thickness of the radially inner portion, which significantly contributes to rigidity, can be effectively increased. Furthermore, in the flange 122, the increase in thickness of the radially outer portion, where the axial direction stress is low, can be effectively curtailed.

### Second Embodiment

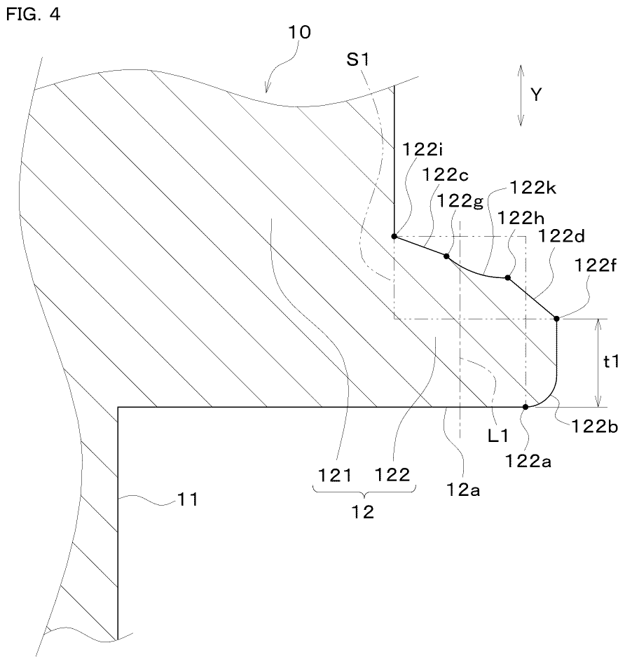

In the first embodiment above, the recess 122e has the shape obtained by notching the inclined surface of the flange 122 in the L-shape in the axial cross-section, however, in the second embodiment, as shown in FIG. 4, the recess 122k formed in the inclined surface of the flange 122 has a shape obtained by notching the inclined surface of the flange 122 in an arc shape in the axial cross-section.

In the cross section in the axial direction of the flange 122, the tangent line (not shown) of the recess 122k at the connection portion 122h with the outer inclined surface 122d is parallel to the bearing surface 12a. Thus, the recess 122k is formed so as to come closer to the bearing surface 12a as going toward the outside in a radial direction. Furthermore, the recess 122k is formed so as to come closest to the bearing surface 12a at the outermost edge of the recess 122k.

Also in the second embodiment, similarly to in the first embodiment, the recess 122k is formed in the inclined surface of the flange 122, so that the concentration point of internal stress in the flange 122 at the time of fastening can be created at the recess 122k. Therefore, the fastening can be made stronger than that when the concentration point of the internal stress in the flange 122 exists only at the innermost radial portion 122i of the flange 122.

### Third Embodiment

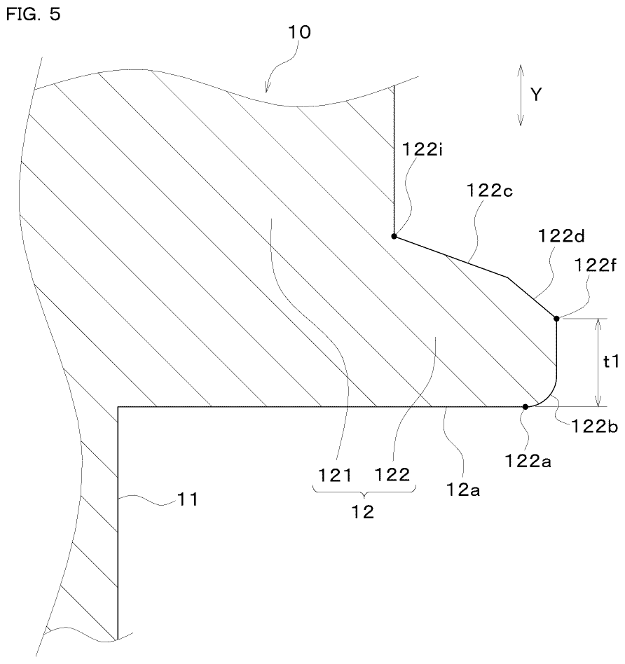

In the first and second embodiments, the inner inclined surface 122c, the outer inclined surface 122d, and the recesses 122e and 122k are formed in the inclined surface of the flange 122, in the meanwhile, in the third embodiment, as shown in FIG. 5, the recesses 122e and 122k are not formed in the inclined surface of the flange 122 and only the inner inclined surface 122c and the outer inclined surface 122d are formed therein.

Also in the third embodiment, similarly to in the first and second embodiments, operational advantage of the inner inclined surface 122c and the outer inclined surface 122d can be achieved. Specifically, the outer inclined surface 122d of the flange 122 has a larger inclination angle than the inner inclined surface 122c. Thus, in the flange 122, the thickness at the position closer to the head main body 121, which significantly contributes to rigidity, can be increased. As a result, the rigidity of the flange 122 can be increased. Furthermore, the increase in thickness of the radially outer portion of the flange 122, where the axial direction stress is low, can be curtailed. Therefore, the increase in weight of the first fastening member 10 can be curtailed. Consequently, the fastening with the first fastening member 10 can be made stronger while the increase in weight of the first fastening member 10 is curtailed.

### Fourth Embodiment

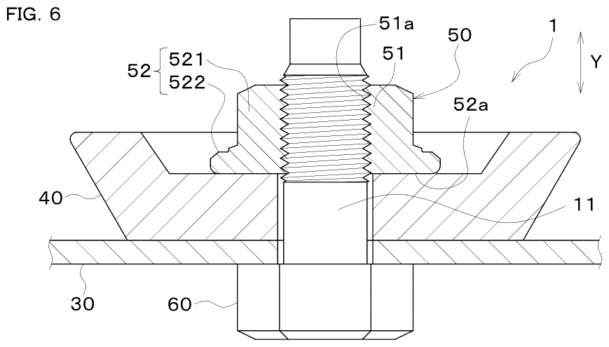

In the first embodiment, the first fastening member 10 is a flanged bolt, the second fastening member 20 is a nut, and the inner inclined surface 122c, the outer inclined surface 122d, and the recess 122e are formed in the inclined surface of the flange 122 of the first fastening member 10. In contrast, in the fourth embodiment, as shown in FIG. 6, a first fastening member 50 is a flanged nut, a second fastening member 60 is a bolt, and an inner inclined surface, an outer inclined surface, and a recess, all of which are the same as in the first embodiment, are formed in the inclined surface of the flanged part 522 of the first fastening member 50.

The second fastening member 60 may be a weld bolt that is pre-welded to the first fastening member 30, a flanged bolt that is separate from the first fastening member 30, or a bolt without a flange that is separate from the first fastening member 30.

The first fastening member 50 includes a thread forming portion 51 and a bearing surface forming portion 52. The thread forming portion 51 comprises a portion that is closer to the central axis in the first fastening member 50. On the thread forming portion 51, an internal thread 51a is formed. The bearing surface forming portion 52 comprises an outer circumferential portion of the fastening member 50. The bearing surface forming portion 52 has a bearing surface 52a formed, abutting on the second target fastening member 40. The bearing surface forming portion 52 has a nut main body 521 and a flange 522. In the fourth embodiment, the nut main body 521 has a hexagonal prism shape.

The flange 522 is formed in a shape expanding outward in a radial direction over the entire circumference of the bearing surface forming portion 52 at a position closer to the bearing surface 52a and applies a compressive force to the second target fastening member 40. The bearing surface 52a of the bearing surface forming portion 52 is formed in a continuous manner by the bottom surface of the nut main body 521 and the bottom surface of the flange 522.

On the surface opposite to the bearing surface 52a in the flange 522, an inner inclined surface, an outer inclined surface, and a recess are formed in the same manner as in the first embodiment. Because the specific configurations of the inner inclined surface, the outer inclined surface, and the recess are the same as in the first embodiment, a detailed description is omitted.

Also in the fourth embodiment, the inner inclined surface, the outer inclined surface, and the recess, which are configured in the same manner as in the first embodiment, are formed in the flange 522 of the first fastening member 50, thus the same operational advantage as in the first embodiment can be achieved.

### Other Embodiments

In the abovementioned embodiments, the inner inclined surface, the outer inclined surface, and the recess are formed only in the first fastening member among the first and second fastening members, however, the inner inclined surface, the outer inclined surface, and the recess may be formed in both of the first and second fastening members.

In the abovementioned embodiments, the inner inclined surface and the outer inclined surface are formed in the inclined surface of the flange and the inclination angle of the inclined surface of the flange changes in two steps as going toward the outside in the radial direction, however, the inclination angle of the flange may change in three or more steps. When the inclination angle of the inclined surface of the flange has three or more steps, the inclination angles of the two inclined surfaces each located on both sides of the recess may not necessarily be different from each other, and the inclination angles of the two inclined surfaces each located on both sides of the recess may be the same as each other.

In the abovementioned embodiments, the inclination angles of the inner and outer inclined surfaces of the flange are constant respectively, and the inner and outer inclined surfaces are formed in a straight line when viewed in axial direction cross section, however, the inclination angle of at least one of the inner surface and the outer inclined surface may not necessarily be constant and may be varied. In other words, at least one of the inner inclined surface and the outer inclined surface may be curved when viewed in axial direction cross section.

What is claimed is:

1. A fastening member comprising:
a thread forming portion having an external thread or an internal thread formed thereon; and
a bearing surface forming portion including a bearing surface abutting on a target fastening member, wherein
the bearing surface forming portion includes a flange at a position closer to the bearing surface, the flange being formed in a shape expanding outward in a radial direction and configured to apply a compressive force to the target fastening member,
the flange includes an inclined surface on a surface opposite to the bearing surface, the inclined surface being inclined so as to come closer to the bearing surface as going toward an outside in the radial direction, and
the inclined surface includes:
an inner inclined surface; and
an outer inclined surface located outside the inner inclined surface in the radial direction and having a larger inclination angle with respect to the bearing surface than the inner inclined surface.

2. The fastening member according to claim 1, wherein a boundary between the inner inclined surface and the outer inclined surface is located inside an outermost abutting portion abutting on the target fastening member at an outermost position in the radial direction of the bearing surface.

3. The fastening member according to claim 1, wherein
the inner inclined surface has the inclination angle of 20° to 30°, and
the outer inclined surface has the inclination angle of 35° to 50°.

4. The fastening member according to claim 1, wherein
the flange includes a recess formed between the inner inclined surface and the outer inclined surface on the surface opposite to the bearing surface, and
the recess is formed inside an outermost abutting portion abutting on the target fastening member at an outermost position in the radial direction.

5. The fastening member according to claim 4, wherein the recess has a shape obtained by notching the surface opposite to the bearing surface in the flange so as to have an L-shape in an axial cross-section.

6. The fastening member according to claim 4, wherein the recess has a shape with an outermost edge of the recess in the radial direction located closest to the bearing surface.

7. The fastening member according to claim 4, wherein the recess is formed in the flange between an innermost radial portion located innermost in the radial direction and the outermost abutting portion, and is formed between an outermost radial portion located outermost in the radial direction and the innermost radial portion in an axial direction.

8. The fastening member according to claim 7, wherein the recess is configured to intersect with a virtual line that bisects a radial distance between the innermost radial portion and the outermost abutting portion and is parallel to the axial direction.

9. The fastening member according to claim 1, wherein the inner inclined surface and the outer inclined surface are formed in a linearly tapered shape in a cross section in the axial direction.

10. A fastening member comprising:
a thread forming portion having an external thread or an internal thread formed thereon, and
a bearing surface forming portion including a bearing surface abutting on a target fastening member, wherein
the bearing surface forming portion includes a flange at a position closer to the bearing surface, the flange being formed in a shape expanding outward in a radial direction and configured to apply a compressive force to the target fastening member,
the flange includes a recess formed on a surface opposite to the bearing surface, and
the recess has a shape with an outermost edge of the recess in the radial direction located closest to the bearing surface.
